(19) United States
(12) Patent Application Publication
(10) Pub. No.: US 2015/0217400 A1
(43) Pub. Date: Aug. 6, 2015

(54) METHOD FOR CUTTING OBJECT TO BE PROCESSED

(71) Applicant: HAMAMATSU PHOTONICS K.K., Hamamatsu-shi, Shizuoka (JP)

(72) Inventor: Takeshi Yamada, Hamamatsu-shi (JP)

(21) Appl. No.: 14/422,415

(22) PCT Filed: Aug. 1, 2013
(86) PCT No.: PCT/JP2013/070905

§ 371 Date: Feb. 19, 2015

(30) Foreign Application Priority Data
Aug. 22, 2012 (JP) 2012-183494

(51) Int. Cl. B23K 26/00; B28D 5/00

(52) U.S. Cl. CPC B23K 26/0057; B23K 26/0039; B28D 5/0011

(57) ABSTRACT

The object cutting method comprises the steps of locating a converging point of laser light within a monocrystal sapphire substrate, while using a rear face of the monocrystal sapphire substrate as an entrance surface of the laser light, and relatively moving the converging point from one side to the other side along each of a plurality of lines to cut set parallel to the a-plane and rear face of the substrate, so as to form a modified region within the substrate along each line; and thereafter exerting an external force on the object along each line, so as to extend a fracture occurring from the modified region, thereby cutting the object along each line.

### TECHNICAL FIELD

The present invention relates to an object cutting method for manufacturing a plurality of light-emitting elements by cutting an object to be processed, comprising a monocrystal sapphire substrate, with respect to each of light-emitting element parts.

### BACKGROUND ART

As a conventional object cutting method in the above-mentioned technical field, Patent Literature 1 discloses a method in which separation grooves are formed on front and rear faces of a sapphire substrate by dicing or scribing, and process-modified parts are formed in multiple stages within the sapphire substrate by irradiation with laser light, and then the sapphire substrate is cut along the separation grooves and process-modified parts.

### CITATION LIST

### Patent Literature

Patent Literature 1: Japanese Patent Application Laid-Open No. 2006-245043

### SUMMARY OF INVENTION

### Technical Problem

Meanwhile, in order to cut an object to be processed, comprising the monocrystal sapphire substrate having front and rear faces forming an angle corresponding to an off-angle with the c-plane, with respect to each of light-emitting element parts, when modified regions are formed within the monocrystal sapphire substrate by irradiation with laser light, the amount of meandering of fractures (the range of fractures meandering in the front face or rear face of the monocrystal sapphire substrate) occurring from the modified regions formed along each of a plurality of lines to cut which are parallel to the a-plane and rear face of the monocrystal sapphire substrate may fluctuate, thereby lowering the quantity of thus manufactured light-emitting element.

It is therefore an object of the present invention to provide an object cutting method which can inhibit the amount of meandering of fractures occurring from modified regions formed along each of a plurality of lines to cut which are parallel to the a-plane and rear face of a monocrystal sapphire substrate from fluctuating.

### Solution to Problem

For achieving the above-mentioned object, the inventors conducted diligent studies and, as a result, have found out that the amount of meandering of fractures occurring from modified regions formed along each of a plurality of lines to cut which are parallel to the a-plane and rear face of a monocrystal sapphire substrate fluctuates because of a relationship between the direction of relatively moving the converging point of laser light along the lines to cut and the tilting direction of the r-plane of the monocrystal sapphire substrate. That is, the state of formation of modified regions varies between the cases where the converging point of the laser light is moved from the respective sides where the r-plane and the rear face form acute and obtuse angles to the opposite side and thereby changes the amount of meandering of fractures occurring from the modified regions. The inventors have further conducted studies based on this finding, thereby completing the present invention.

That is, the object cutting method in accordance with one aspect of the present invention is an object cutting method for manufacturing a plurality of light-emitting elements by cutting an object to be processed, comprising a monocrystal sapphire substrate having front and rear faces forming an angle corresponding to an off-angle with c-plane and an element layer including a plurality of light-emitting element parts arranged in a matrix on the front face, with respect to each of the light-emitting element parts, the method comprising a first step of locating a converging point of laser light at a position separated by a first distance from the rear face within the monocrystal sapphire substrate, while using the rear face as an entrance surface of laser light in the monocrystal sapphire substrate, and relatively moving the converging point from one side to the other side along each of a plurality of first lines to cut set parallel to a-plane of the monocrystal sapphire substrate and the rear face, so as to form first modified regions within the monocrystal sapphire substrate along each of the first lines; and a second step of exerting an external force on the object along each of the first lines after the first step, so as to extend a first fracture occurring from the first modified regions, thereby cutting the object along each of the first lines.

This object cutting method relatively moves the converging point of laser light from one side to the other side in each of a plurality of first lines to cut which are set parallel to the a-plane and rear face of the monocrystal sapphire substrate. This can restrain the amount of meandering of first fractures occurring from first modified regions formed along each of the first lines from changing. Hence, this object cutting method can inhibit the amount of meandering of fractures occurring from modified regions formed along each of a plurality of lines to cut parallel to the a-plane and rear face of the monocrystal sapphire substrate from fluctuating. The off-angle may be 0°. In this case, the front and rear faces of the monocrystal sapphire substrate are parallel to the c-plane.

In the first step, assuming that side where r-plane of the monocrystal sapphire substrate and the rear face form an acute angle is the one side while side where the r-plane and the rear face form an obtuse angle is the other side, the converging point may be relatively moved from the one side to the other side along each of the first lines, so as to form the first modified regions within the monocrystal sapphire substrate and cause the first fracture to reach the rear face. This can suppress the amount of meandering of the first fractures reaching the rear face of the monocrystal sapphire substrate from the first modified regions as compared with the case of relatively moving the converging point of the laser light from the side where the angle formed between the r-plane and rear face of the monocrystal sapphire substrate is an obtuse angle to the side where the angle is an acute angle.

Here, in the second step, the external force may be exerted on the object along each of the first lines by pressing a knife edge against the object from the font face side along each of the first lines. This enables the external force to act on the object such that the first fracture having reached the rear face of the monocrystal sapphire substrate opens, thereby making it possible to cut the object easily and accurately along the first lines.

The object cutting method may further comprise a third step of locating the converging point within the monocrystal sapphire substrate, while using the rear face as the entrance surface, and relatively moving the converging point along each of a plurality of second lines to cut set parallel to m-plane of the monocrystal sapphire substrate and the rear face, so as to form second modified regions within the monocrystal sapphire substrate along each of the second lines before the second step; and a fourth step of exerting an external force on the object along each of the second lines after the first and third steps, so as to extend a second fracture occurring from the second modified regions, thereby cutting the object along each of the second lines. This can easily and accurately cut the object along the first and second lines. The third step may be performed either before or after the first step as long as it occurs before the second step. The fourth step may be performed either before or after the fourth step as long as it occurs after the first and third steps.

In the first step, the converging point may be located at a position separated by a second distance greater than the first distance from the rear face within the monocrystal sapphire substrate, while using the rear face as the entrance surface, and the converging point may be relatively moved from the other side to the one side along each of the first lines, so as to form third modified regions within the monocrystal sapphire substrate along each of the first lines, and in the second step, the external force may be exerted on the object along each of the first lines, so as to extend the first fracture and a third fracture occurring from the third modified regions, thereby cutting the object along each of the first lines. This can easily and accurately cut the object along the first lines even when the monocrystal sapphire substrate is relatively thick. Moving the converging point of the laser light in directions opposite from each other for forming the first and third modified regions can efficiently move the converging point of the laser light when continuously forming the third and first modified regions in sequence, for example.

Alternatively, in the first step, the converging point may be located at a position separated by a second distance greater than the first distance from the rear face within the monocrystal sapphire substrate, while using the rear face as the entrance surface, and the converging point may be relatively moved from the one side to the other side along each of the first lines, so as to form third modified regions within the monocrystal sapphire substrate along each of the first lines, and in the second step, the external force may be exerted on the object along each of the first lines, so as to extend the first fracture and a third fracture occurring from the third modified regions, thereby cutting the object along each of the first lines. This can easily and accurately cut the object along the first lines even when the monocrystal sapphire substrate is relatively thick. Moving the converging point of the laser light in the same direction for forming the first and third modified regions enables the first fracture to securely reach the rear face of the monocrystal sapphire substrate when forming the first modified regions.

### Advantageous Effects of Invention

The present invention can provide an object cutting method which can inhibit the amount of meandering of fractures occurring from modified regions formed along each of a plurality of lines to cut which are parallel to the a-plane and rear face of a monocrystal sapphire substrate from fluctuating.

### BRIEF DESCRIPTION OF DRAWINGS

FIG. 1 is a schematic structural diagram of a laser processing device used for forming a modified region;

FIG. 2 is a plan view of an object to be processed for which the modified region is formed;

FIG. 3 is a sectional view of the object taken along the line III-III of FIG. 2;

FIG. 4 is a plan view of the object after laser processing;

FIG. 5 is a sectional view of the object taken along the line V-V of FIG. 4;

FIG. 6 is a sectional view of the object taken along the line VI-VI of FIG. 4;

FIG. 7 is a plan view of the object to be subjected to the object cutting method in accordance with a first embodiment of the present invention;

FIG. 8 is a unit cell diagram of a monocrystal sapphire substrate serving as the object of FIG. 7;

FIG. 9 is a sectional view of an object to be processed for explaining the object cutting method in accordance with the first embodiment of the present invention;

FIG. 10 is a plan view of the object for explaining a street region in the object in FIG. 7;

FIG. 11 is a sectional view of the object for explaining the object cutting method in accordance with the first embodiment of the present invention;

FIG. 12 is a sectional view of the object for explaining the object cutting method in accordance with the first embodiment of the present invention;

FIG. 13 is a sectional view of the object for explaining the object cutting method in accordance with the first embodiment of the present invention;

FIG. 14 is a sectional view of the object for explaining the object cutting method in accordance with the first embodiment of the present invention;

FIG. 15 is a sectional view of the object for explaining the object cutting method in accordance with a second embodiment of the present invention;

FIG. 16 is a sectional view of the object for explaining the object cutting method in accordance with the second embodiment of the present invention;

FIG. 17 is a sectional view of the object for explaining the object cutting method in accordance with the second embodiment of the present invention;

FIG. 18 is a sectional view of the object for explaining the object cutting method in accordance with the second embodiment of the present invention;

FIG. 19 is a sectional view of the object for explaining the object cutting method in accordance with a third embodiment of the present invention;

FIG. 20 is a sectional view of the object for explaining the object cutting method in accordance with the third embodiment of the present invention; and

FIG. 21 is a sectional view of the object for explaining the object cutting method in accordance with the third embodiment of the present invention.

### DESCRIPTION OF EMBODIMENTS

In the following, preferred embodiments of the present invention will be explained in detail with reference to the drawings. In the drawings, the same or equivalent parts will be referred to with the same signs while omitting their overlapping descriptions.

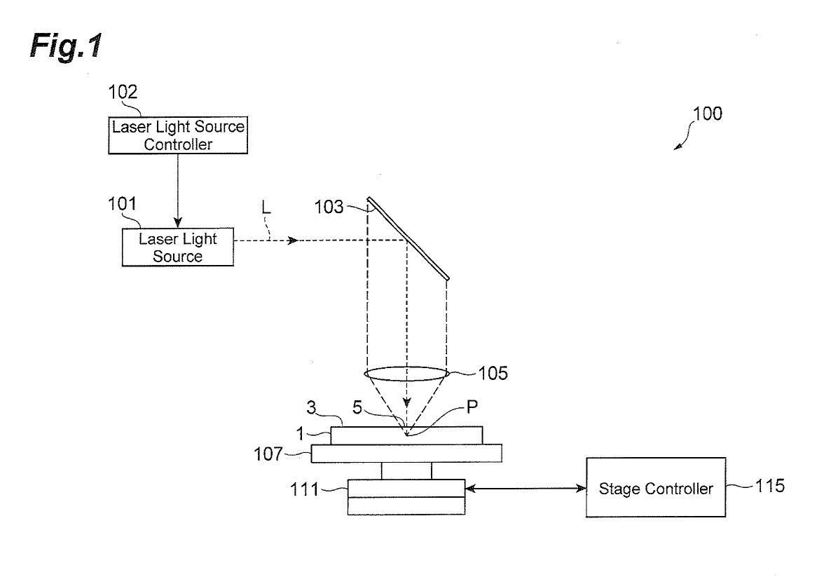

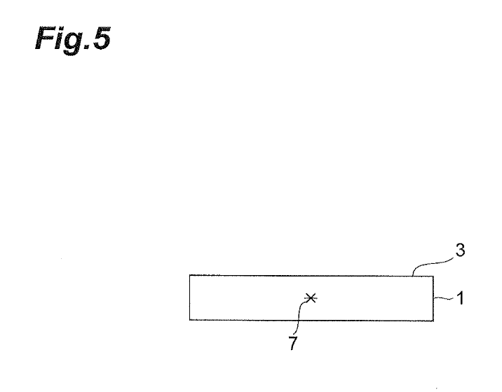

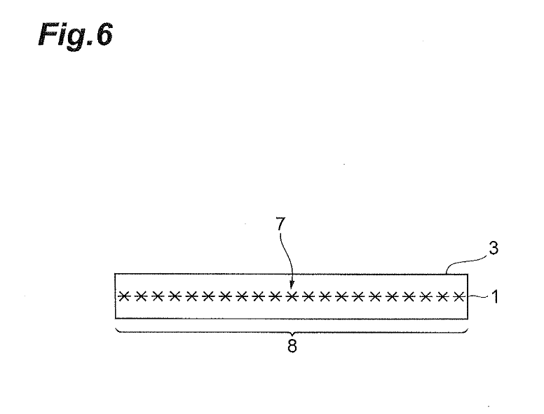

The object cutting method in accordance with an embodiment of the present invention irradiates an object to be processed with laser light along a line to cut, so as to form a modified region within the object along the line. Therefore, the forming of the modified region will be explained at first with reference to FIGS. 1 to 6.

As illustrated in FIG. 1, a laser processing device 100 comprises a laser light source 101 for causing laser light L to oscillate in a pulsating manner, a dichroic mirror 103 arranged such as to change the direction of the optical axis (optical path) of the laser light L by 90°, and a condenser lens (condenser optical system) 105 for condensing the laser light L. The laser processing device 100 further comprises a support table 107 for supporting an object to be processed 1 which is irradiated with the laser light L condensed by the condenser lens 105, a stage 111 for moving the support table 107, a laser light source controller 102 for regulating the laser light source 101 in order to adjust the output, pulse width, pulse waveform, and the like of the laser light L, and a stage controller 115 for regulating the movement of the stage 111.

In the laser processing device 100, the laser light L emitted from the laser light source 101 changes the direction of its optical axis by 90° with the dichroic mirror 103 and then is condensed by the condenser lens 105 into the object 1 mounted on the support table 107. At the same time, the stage 111 is shifted, so that the object 1 moves relative to the laser light L along a line to cut 5. This forms a modified region in the object 1 along the line 5.

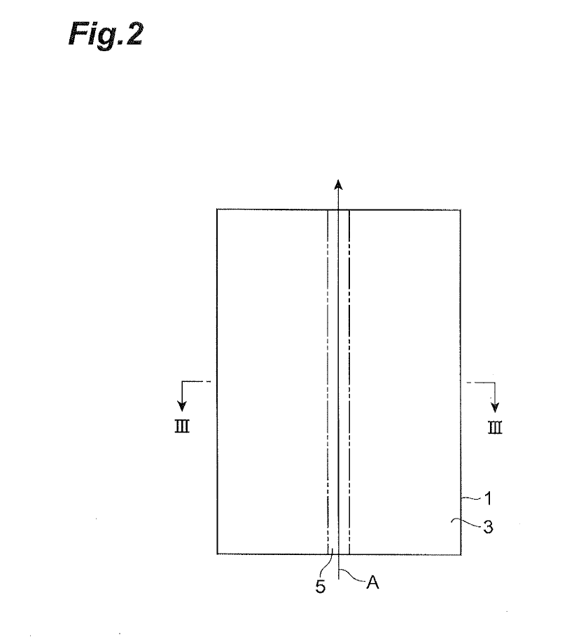

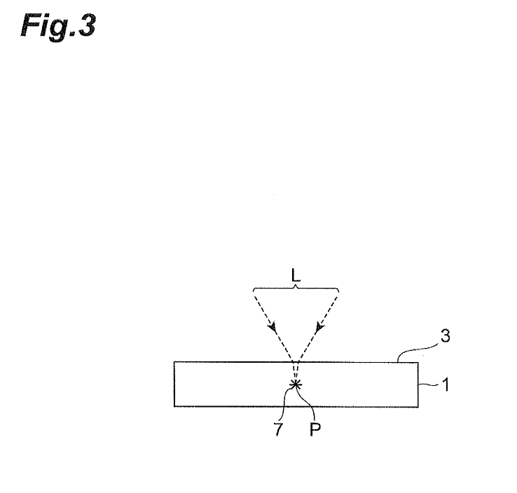

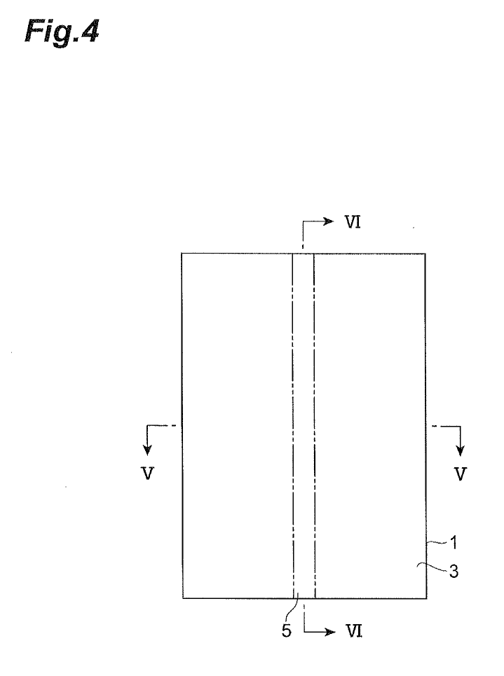

As illustrated in FIG. 2, the line 5 for cutting the object 1 is set in the object 1. The line 5 is a virtual line extending straight. When forming a modified region within the object 1, the laser light L is relatively moved along the line 5 (i.e., in the direction of arrow A in FIG. 2) while locating a converging point P within the object 1 as illustrated in FIG. 3. This forms a modified region 7 within the object 1 along the line 5 as illustrated in FIGS. 4 to 6, whereby the modified region 7 formed along the line 5 becomes a cutting start region 8.

The converging point P is a position at which the laser light L is condensed. The line 5 may be curved instead of being straight and may be one actually drawn on a front face 3 of the object 1 without being restricted to the virtual line. The modified region 7 may be formed either continuously or intermittently. The modified region 7 may be formed either in rows or dots and is only required to be formed at least within the object 1. There are cases where fractures are formed from the modified region 7 acting as a start point, and the fractures and modified region 7 may be exposed at outer surfaces (the front face 3, rear face 21, and outer peripheral surface) of the object 1.

Here, the laser light L is absorbed in particular in the vicinity of the converging point within the object 1 while being transmitted therethrough, whereby the modified region 7 is formed in the object 1 (i.e., internal absorption type laser processing). Therefore, the front face 3 of the object 1 hardly absorbs the laser light L and thus does not melt. In the case of forming a removing part such as a hole or groove by melting it away from the front face 3 (surface absorption type laser processing), the processing region gradually progresses from the front face 3 side to the rear face side in general.

By the modified region formed in this embodiment are meant regions whose physical characteristics such as density, refractive index, and mechanical strength have attained states different from those of their surroundings. Examples of the modified region include molten processed regions, crack regions, dielectric breakdown regions, refractive index changed regions, and their mixed regions. Other examples of the modified region include areas where the density of the modified region has changed from that of an unmodified region and areas formed with a lattice defect in a material of the object (which may also collectively be referred to as high-density transitional regions).

The molten processed regions, refractive index changed regions, areas where the modified region has a density different from that of the unmodified region, or areas formed with a lattice defect may further incorporate a fracture (fissure or microcrack) therewithin or at an interface between the modified and unmodified regions. The incorporated fracture may be formed over the whole surface of the modified region or in only a part or a plurality of parts thereof.

This embodiment forms a plurality of modified spots (processing scars) along the line 5, thereby producing the modified region 7. The modified spots, each of which is a modified part formed by a shot of one pulse of pulsed laser light (i.e., one pulse of laser irradiation; laser shot), gather to yield the modified region 7. Examples of the modified spots include crack spots, molten processed spots, refractive index changed spots, and those in which at least one of them is mixed.

Preferably, for the modified spots, their sizes and lengths of fractures generated therefrom are controlled as appropriate in view of the required cutting accuracy, the demanded flatness of cut surfaces, the thickness, kind, and crystal orientation of the object, and the like.

### First Embodiment

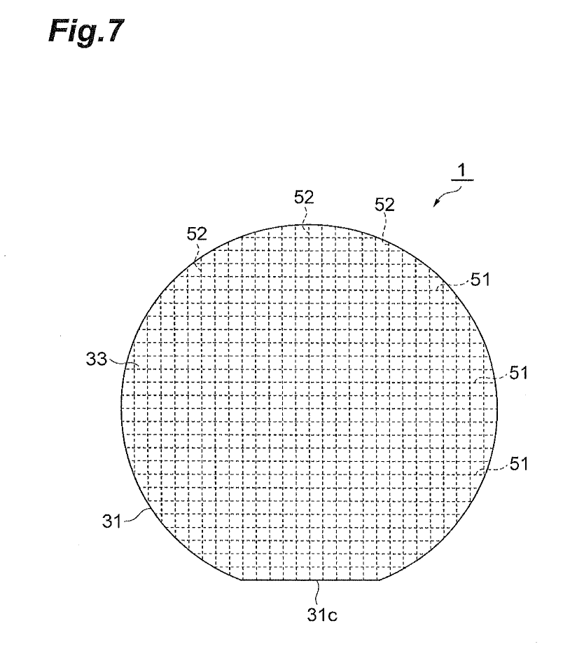

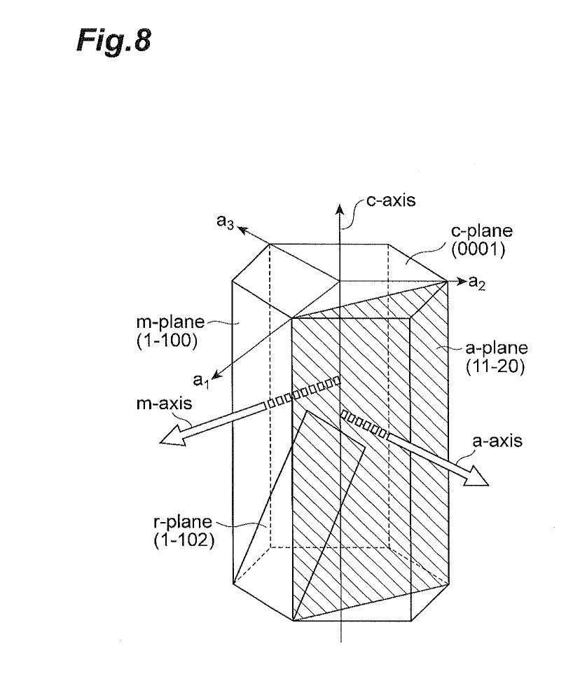

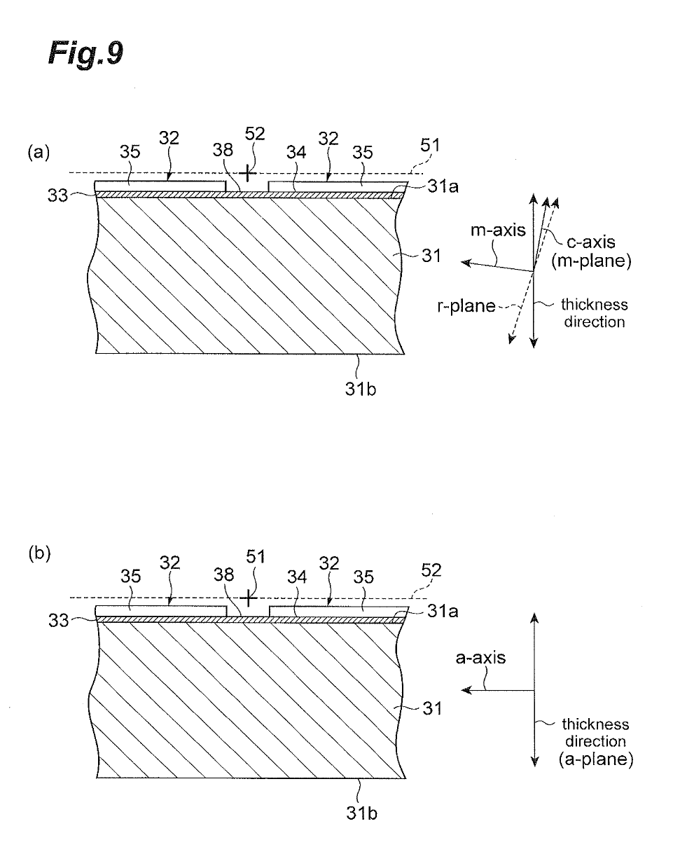

The object cutting method in accordance with the first embodiment of the present invention will now be explained in detail. As illustrated in FIG. 7, the object 1 is a wafer comprising a monocrystal sapphire substrate 31 having a disk shape (e.g., with a diameter of 2 to 6 inches and a thickness of 50 to 200 μm). As illustrated in FIG. 8, the monocrystal sapphire substrate 31 has a hexagonal crystal structure, whose c-axis is tilted by an angle θ (e.g., 0.1°) with respect to the thickness direction of the monocrystal sapphire substrate 31. That is, the monocrystal sapphire substrate 31 has an off-angle of the angle θ. As illustrated in FIG. 9, the monocrystal sapphire substrate 31 has front and rear faces 31a, 31 b each forming the angle θ corresponding to the off-angle with the c-plane. In the monocrystal sapphire substrate 31, the m-plane is tilted by the angle θ with respect to the thickness direction of the monocrystal sapphire substrate 31 (see FIG. 9(a)), while the a-plane is parallel to the thickness direction of the monocrystal sapphire substrate 31 (see FIG. 9(b)).

As illustrated in FIGS. 7 and 9, the object 1 comprises an element layer 33 including a plurality of light-emitting element parts 32 arranged in a matrix on the front face 31a of the monocrystal sapphire substrate 31. In the object 1, lines to cut (first and second lines to cut) 51, 52 for cutting the object 1 with respect to each of the light-emitting element parts 32 are arranged into a grid (e.g., 300 μm×300 μm). A plurality of the lines 51 are set parallel to the a-plane and rear face 31b (i.e., parallel to the a-plane and front face 31a). A plurality of the lines 52 are set parallel to the m-plane and rear face 31b (i.e., parallel to the m-plane and front face 31a). The monocrystal sapphire substrate 31 is formed with an orientation flat 31c parallel to the a-plane.

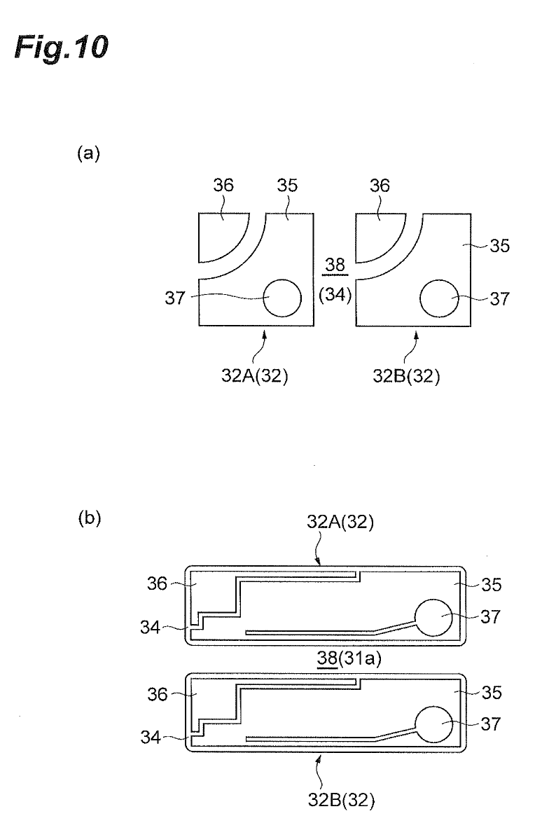

As illustrated in FIG. 9, each light-emitting element part 31 has an n-type semiconductor layer (first conduction type semiconductor layer) 34 mounted on the front face 31a of the monocrystal sapphire substrate 31 and a p-type semiconductor layer (second conduction type semiconductor layer) 35 mounted on the n-type semiconductor layer 34. The n-type semiconductor layer 34 is continuously formed all over the light-emitting element parts 32, while the p-type semiconductor layer 35 is formed into islands separated with respect to each of the light-emitting element parts 32. The n-type semiconductor layer 34 and p-type semiconductor layer 35 are made of a compound semiconductor such as GaN, for example, and have a p-n junction therebetween. As illustrated in FIG. 10, the n-type semiconductor layer 34 is formed with electrode pads 36 for each of the light-emitting element parts 32, while the p-type semiconductor layer 35 is formed with electrode pads 37 for each of the light-emitting element parts 32. The n-type semiconductor layer 34 has a thickness of about 6 μm, for example, while the p-type semiconductor layer 35 has a thickness of about 1 μm, for example.

Between the light-emitting element parts 32, 32 adjacent to each other in the element layer 33, a street region 38 having a predetermined width (e.g., 10 to 30 μm) extends like a grid. When attention is focused on light-emitting element parts 32A, 32B adjacent to each other, the street region 38 is a region between a member having the outer edge closest to one light-emitting element part 32A in members exclusively possessed by the other light-emitting element part 32B and a member having the outer edge closest to the other light-emitting element part 32B in members exclusively possessed by the one light-emitting element part 32A.

In the case of FIG. 10(a), for example, the member having the outer edge closest to the light-emitting element part 32B in the members exclusively possessed by the light-emitting element part 32A is the p-type semiconductor layer 35, while the members having the outer edge closest to the light-emitting element part 32A in the members exclusively possessed by the light-emitting element part 32B are the electrode pad 36 and p-type semiconductor layer 35. Therefore, the street region 38 in this case is a region between the p-type semiconductor layer 35 of the light-emitting element part 32A and the electrode pad 36 and p-type semiconductor layer 35 of the light-emitting element part 32B. In the case of FIG. 10(a), the n-type semiconductor layer 34 shared by the light-emitting element parts 32A, 32B is exposed to the street region 38.

In the case of FIG. 10(b), on the other hand, the member having the outer edge closest to the light-emitting element part 32B in the members exclusively possessed by the light-emitting element part 32A is the n-type semiconductor layer 34, and the member having the outer edge closest to the light-emitting element part 32A in the members exclusively possessed by the light-emitting element part 32B is also the n-type semiconductor layer 34. Therefore, the street region 38 in this case is a region between the n-type semiconductor layer 34 of the light-emitting element part 32A and the n-type semiconductor layer 34 of the light-emitting element part 32B. In the case of FIG. 10(b), the front face 31a of the monocrystal sapphire substrate 31 is exposed to the street region 38.

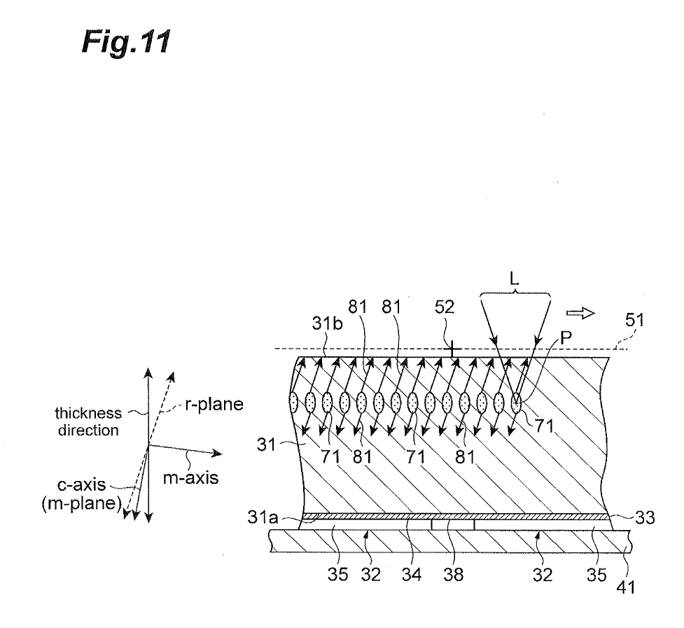

An object cutting method for cutting thus constructed object 1 with respect to each of the light-emitting element parts 32 in order to manufacture a plurality of light-emitting elements will now be explained. First, as illustrated in FIG. 11, a protective tape 41 is attached to the object 1 so as to cover the element layer 33, and the object 1 is mounted on the support table 107 of the laser processing device 100 with the protective tape 41 interposed therebetween. Subsequently, while using the rear face 31b of the monocrystal sapphire substrate 31 as the entrance surface of the laser light L in the monocrystal sapphire substrate 31 and locating the converging point P of the laser light L within the monocrystal sapphire substrate 31, the converging point P is relatively moved along each of the lines 51. This forms modified regions (first modified regions) 71 within the monocrystal sapphire substrate 31 along each of the lines 51 and causes fractures (first fractures) 81 occurring from the modified regions 71 to reach the rear face 31b (first step). At this time, the fractures 81 also extend from the modified regions 71 toward the front face 31a of the monocrystal sapphire substrate 31 but do not reach the front face 31a.

In this step, assuming that the side on which the r-plane and rear face 31b of the monocrystal sapphire substrate 31 form an acute angle is one side while the side on which they form an obtuse angle is the other side, the converging point P of the laser light L is relatively moved from the one side to the other side in all of the lines 51. For example, the distance from the rear face 31b to the position where the converging point P is located (first distance) is one half or less of the thickness of the monocrystal sapphire substrate 31, e.g., 30 to 50 μm.

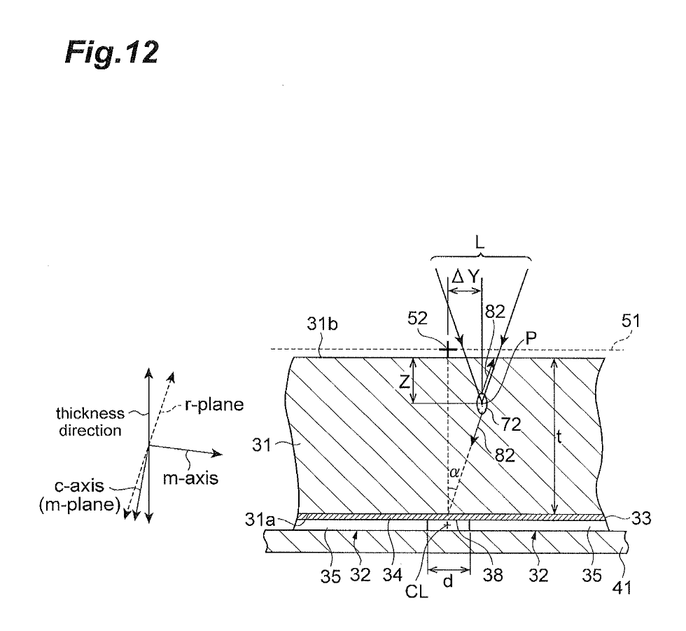

Next, as illustrated in FIG. 12, while using the rear face 31b of the monocrystal sapphire substrate 31 as the entrance surface of the laser light L in the monocrystal sapphire substrate 31 and locating the converging point P of the laser light L within the monocrystal sapphire substrate 31, the converging point P is relatively moved along each of the lines 52. This forms modified regions (second modified regions) 72 within the monocrystal sapphire substrate 31 along each of the lines 52 and causes fractures (second fractures) 82 occurring from the modified regions 72 to reach the rear face 31b (third step). At this time, the fractures 82 also extend from the modified regions 72 toward the front face 31a of the monocrystal sapphire substrate 31 but do not reach the front face 31a.

This step irradiates the object 1 with the laser light L along each of the lines 52 so as to satisfy ΔY=(tan α)·(t−Z)±[(d/2)−m], where ΔY is the distance as seen in a direction perpendicular to the rear face 31b from a center line CL of the street region 38 extending in a direction parallel to the m-plane between the light-emitting element parts 32, 32 adjacent to each other to the position where the converging point P is located, t is the thickness of the monocrystal sapphire substrate 31, Z is the distance from the rear face 31b to the position where the converging point P is located, d is the width of the street region 38, m is the amount of meandering of the fracture 82 in the front face 31a, and α is the angle formed between the direction perpendicular to the rear face 31b (i.e., the thickness direction of the monocrystal sapphire substrate 31) and the fracture 82.

Here, the center line CL is the center line in the width direction of the street region 38 (i.e., the direction in which the light-emitting element parts 32, 32 adjacent to each other are juxtaposed). The amount of meandering m of the fracture 82 in the front face 31a is an estimated maximum value of the range (in the width direction of the street region 38) of the fracture 82 meandering in the front face 31a, an example of which is −5 to +5 μm. While the direction in which the fractures 82 extend is a direction inclined to the side on which the r-plane tilts with respect to the direction perpendicular to the rear face 31b, the angle α formed between the direction perpendicular to the rear face 31b and the direction in which the fractures 82 extend does not always coincide with the angle formed between the direction perpendicular to the rear face 31b and the r-plane, but may be 5 to 7°, for example.

The laser processing device 100 operates as follows in this step. First, from the rear face 31b side of the monocrystal sapphire substrate 31, the laser processing device 100 detects the street region 38 extending in the direction parallel to the m-plane between the light-emitting elements 32, 32 adjacent to each other. Subsequently, the laser processing device 100 adjusts the position at which the object 1 is irradiated with the laser light L such that the position at which the converging point P is located is positioned on the center line CL of the street region 38 when seen in the direction perpendicular to the rear face 31b. Then, the laser processing device 100 adjusts the position at which the object 1 is irradiated with the laser light L such that the position at which the converging point P is located is offset by ΔY from the center line CL when seen in the direction perpendicular to the rear face 31b. Next, the laser processing device 100 starts irradiating the object 1 with the laser light L and relatively moves the converging point P along each of the lines 52 while the position at which the converging point P is located is offset by ΔY from the center line CL (coinciding with the line 52 here) when seen in the direction perpendicular to the rear face 31b.

Here, the modified regions 71, 72 formed within the monocrystal sapphire substrate 31 include molten processed regions. Appropriately adjusting irradiation conditions of the laser light L enables the fractures 81, 82 occurring from the modified regions 71, 72 to reach the rear face 31b of the monocrystal sapphire substrate 31. Examples of the irradiation conditions of the laser light L for the fractures 81, 82 to reach the rear face 31b include the distance from the rear face 31b to the position at which the converging point P of the laser light L is located, the pulse width of the laser light L, the pulse pitch of the laser light L (“the moving speed of the laser light L with respect to the object 1” divided by “the repetition frequency of the laser light L”), and the pulse energy of the laser light L. In the monocrystal sapphire substrate 31, the fractures 81 are hard to extend but easy to meander in the lines 51 set parallel to the a-plane and rear face 12b. On the other hand, the fractures 82 are easy to extend but hard to meander in the lines 52 set parallel to the m-plane and rear face 12b. From this viewpoint, the pulse pitch of the laser light L on the line 51 side may be made smaller than that on the line 52 side.

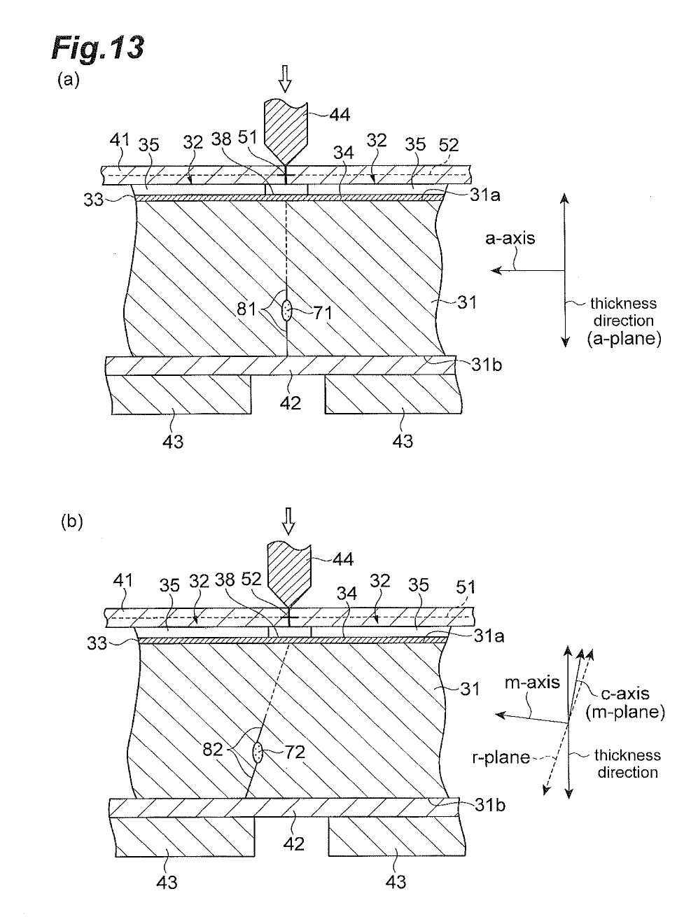

After forming the modified regions 71, 72 as in the foregoing, as illustrated in FIG. 13, an expandable tape 42 is attached to the object 1 so as to cover the rear face 31b of the monocrystal sapphire substrate 31, and the object 1 is mounted on a receiving member 43 of a three-point bending breaking device with the expandable tape 42 interposed therebetween. Subsequently, as illustrated in FIG. 13(a), a knife edge 44 is pressed against the object 1 through the protective tape 41 from the front face 31a side of the monocrystal sapphire substrate 31 along each of the lines 51, so as to exert an external force on the object 1 along each of the lines 51. This causes the fractures 81 occurring from the modified regions 71 to extend toward the front face 31a, thereby cutting the object 1 into bars along each of the lines 51 (second step).

Next, as illustrated in FIG. 13(b), the knife edge 44 is pressed against the object 1 through the protective tape 41 from the front face 31a side of the monocrystal sapphire substrate 31 along each of the lines 52, so as to exert an external force on the object 1 along each of the lines 52. This causes the fractures 82 occurring from the modified regions 72 to extend toward the front face 31a, thereby cutting the object 1 into chips along each of the lines 52 (fourth step).

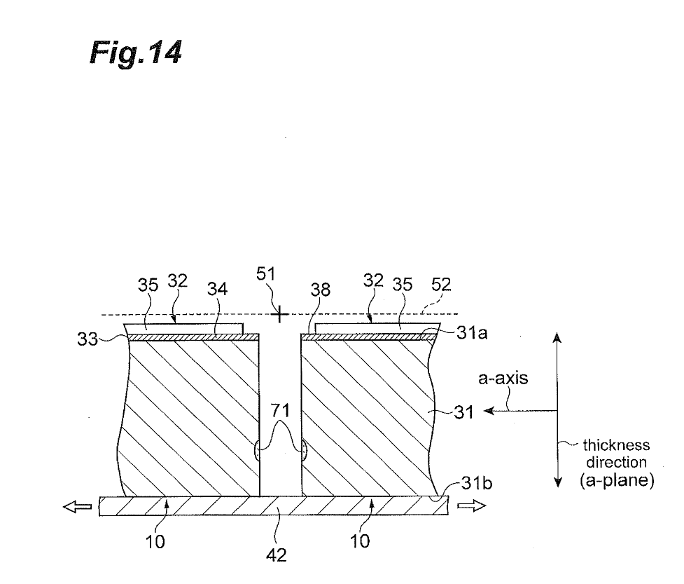

After cutting the object 1, as illustrated in FIG. 14, the protective tape 41 is removed from the object 1, and the expandable tape 42 is expanded outward. As a consequence, a plurality of light-emitting elements 10, which were obtained by cutting the object 1 into the chips, are separated from each other.

As explained in the foregoing, the object cutting method of the first embodiment relatively moves the converging point P of the laser light L from one side to the other side in each of a plurality of lines to cut 51 which are set parallel to the a-plane and rear face 31b of the monocrystal sapphire substrate 31. This can restrain the fractures 81 occurring from the modified regions 71 formed along each of the lines 51 from changing their amount of meandering. This is based on the finding that the state of formation of the modified regions 71 varies between the cases where the converging point P of the laser light L is moved from the respective sides where the r-plane and the rear face 31b form acute and obtuse angles to the opposite side and thereby changes the amount of meandering of the fractures 81 occurring from the modified regions 71. Hence, this object cutting method can inhibit the amount of meandering of the fractures 82 occurring from the modified regions 71 formed along each of a plurality of lines to cut 51 parallel to the a-plane and rear face 31b of the monocrystal sapphire substrate 31 from fluctuating. By the amount of meandering of the fractures 81 occurring from the modified regions 71 is meant the range (in the width direction of the street region 38) of the fractures 81 meandering in the front face 31a or rear face 31b of the monocrystal sapphire substrate 31.

Assuming that the side on which the r-plane and rear face 31b of the monocrystal sapphire substrate 31 form an acute angle is one side while the side on which they form an obtuse angle is the other side, the step of forming the modified regions 71 relatively moves the converging point P of the laser light L from the one side to the other side in each of the lines 51, so as to form the modified regions 71 within the substrate 31 and cause the fractures 81 occurring from the modified regions 71 to reach the rear face 31b. As a consequence, the amount of meandering of the fractures 81 reaching from the modified regions 71 to the rear face 31b of the monocrystal sapphire substrate 31 can be made smaller than that in the case where the converging point P of the laser light L is relatively moved from the side on which the r-plane and rear face 31b of the monocrystal sapphire substrate 31 form an obtuse angle to the side on which they form an acute angle.

The step of cutting the object 1 presses the knife edge 44 against the object 1 from the front face 31a side of the monocrystal sapphire substrate 31 along each of the lines 51, 52, thereby exerting an external force on each of the lines 51, 52. As a consequence, the external force acts on the object 1 such that the fractures 81, 82 having reached the rear face 31b of the monocrystal sapphire substrate 31 open, whereby the object 1 can be cut easily and accurately along the lines 51, 52.

The object 1 is irradiated with the laser light L so as to satisfy ΔY=(tan α)·(t−Z)±[(d/2)−m] in each of a plurality of lines to cut 52 set parallel to the m-plane and rear face 31b of the monocrystal sapphire substrate 31, thereby forming the modified regions 72 within the monocrystal sapphire substrate 31 and causing the fractures 82 occurring from the modified regions 72 to reach the rear face 31b. As a consequence, even when the extending direction of the fractures 82 occurring from the modified regions 72 is pulled toward the tilting direction of the r-plane, the fractures 82 can be contained in the street region 38 in the front face 31a of the monocrystal sapphire substrate 31, whereby the fractures 81 can be prevented from reaching the light-emitting element parts 32. This is based on the finding that the extending direction of the fractures 82 occurring from the modified regions 72 formed along the lines 52 parallel to the m-plane and rear face 31b of the monocrystal sapphire substrate 31 is influenced more by the r-plane tilted from the m-plane than by the m-plane, so as to be pulled toward the tilting direction of the r-plane. Offsetting the locating position of the converging point P by ΔY from the center line CL of the street region 38 as seen in the direction perpendicular to the rear face 31b makes it possible for the fractures 82 occurring from the modified regions 72 to be contained in the street region 38 even when the locating position of the converging point P is separated from the front face 31a of the monocrystal sapphire substrate 31, whereby characteristics of the light-emitting element parts 32 can be prevented from deteriorating upon irradiation with the laser light L.

For example, when t (the thickness of the monocrystal sapphire substrate 31): 150 μm, Z (the distance from the rear face 31b to the position where the converging point P is located): 50 μm, d (the width of the street region 38): 20 μm, m (the amount of meandering of the fracture 82 in the front face 31a): 3 μm, and the tangent of α (the angle formed between the direction perpendicular to the rear face 31b and the extending direction of the rear face 82): 1/10, ΔY=10±7 μm from ΔY=(tan α)·(t−Z)±[(d/2)−m]. It is therefore sufficient for the converging point P to be moved relatively along each of the lines 52 while the position at which the converging point P is located is offset by 3 to 17 μm from the center line CL of the street region 38 when seen in the direction perpendicular to the rear face 31b.

### Second Embodiment

The object cutting method in accordance with the second embodiment of the present invention will now be explained in detail. The object cutting method of the second embodiment differs from the above-mentioned object cutting method of the first embodiment in the steps of forming the modified regions 72 and cutting the object 1. In the following, the object cutting method of the second embodiment will be explained mainly in terms of these different steps.

First, as with the above-mentioned object cutting method of the first embodiment, the object 1 is irradiated with the laser light L along each of the lines 51, so as to form the modified regions 71 within the monocrystal sapphire substrate 31 along each of the lines 51 and cause the fractures 81 occurring from the modified regions 71 to reach the rear face 31b of the monocrystal sapphire substrate 31 (first step).

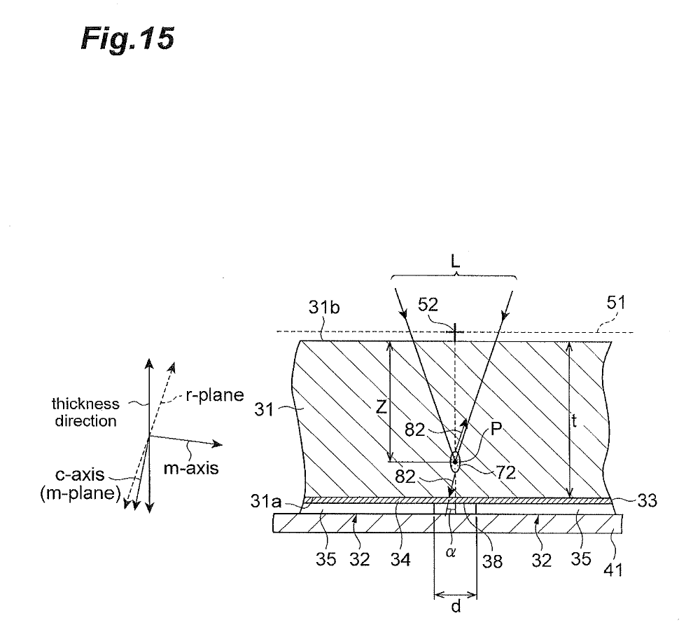

Subsequently, as illustrated in FIG. 15, the converging point P of the laser light is relatively moved along each of the lines 52, while using the rear face 31b of the monocrystal sapphire substrate 31 as the entrance surface of the laser light L in the monocrystal sapphire substrate 31 and locating the converging point within the monocrystal sapphire substrate 31. This forms the modified regions 72 within the monocrystal sapphire substrate 31 along each of the lines 52 and causes the fractures 82 occurring from the modified regions 72 to reach the front face 31a of the monocrystal sapphire substrate (third step). At this time, the fractures 82 extend from the modified regions 72 toward the rear face 31b of the monocrystal sapphire substrate 31 but do not reach the rear face 31b.

This step irradiates the object 1 with the laser light L along each of the lines 52 so as to satisfy t−[(d/2)−m]/tan α<Z<t−e, where e is the minimum allowable distance from a position where the converging point P is located to the front face 31a, t is the thickness of the monocrystal sapphire substrate 31, Z is the distance from the rear face 31b to the position where the converging point P is located, d is the width of the street region 38 extending in a direction parallel to the m-plane between the light-emitting element parts 32, 32 adjacent to each other, m is the amount of meandering of the fracture 82 in the front face 31a, and α is the angle formed between the direction perpendicular to the rear face 31b (i.e., the thickness direction of the monocrystal sapphire substrate 31) and the fracture 82.

Here, the minimum allowable distance e from a position where the converging point P is located to the front face 31a is such a distance that a characteristic of the light-emitting element parts 32 may deteriorate upon irradiation with the laser light L if the distance from the position where the converging point P is located to the front face 31a is shorter than the minimum allowable distance e, an example of which is 40 to 60 μm.

Here, appropriately adjusting irradiation conditions of the laser light L enables the fractures 82 occurring from the modified regions 72 to reach the front face 31a of the monocrystal sapphire substrate 31. Examples of the irradiation conditions of the laser light L for the fractures 82 to reach the front face 31a include the distance from the rear face 31b to the position at which the converging point P of the laser light L is located, the pulse width of the laser light L, the pulse pitch of the laser light L, and the pulse energy of the laser light L.

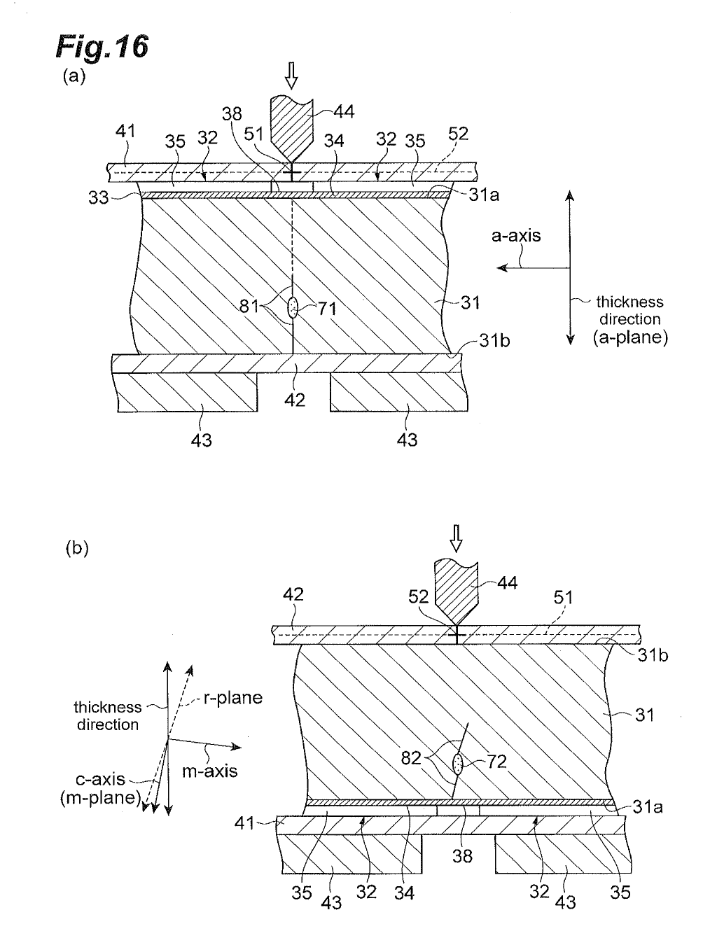

After forming the modified regions 71, 72 as in the foregoing, as illustrated in FIG. 16(a), the expandable tape 42 is attached to the object 1 so as to cover the rear face 31b of the monocrystal sapphire substrate 31, and the object 1 is mounted on the receiving member 43 of the three-point bending breaking device with the expandable tape 42 interposed therebetween. Subsequently, a knife edge 44 is pressed against the object 1 through the protective tape 41 from the front face 31a side of the monocrystal sapphire substrate 31 along each of the lines 51, so as to exert an external force on the object 1 along each of the lines 51. This causes the fractures 81 occurring from the modified regions 71 to extend toward the front face 31a, thereby cutting the object 1 into bars along each of the lines 51 (second step).

Next, as illustrated in FIG. 16(b), the object 1 is reversed and mounted on the receiving member 43 of the three-point bending breaking device with the protective tape 41 interposed therebetween. Subsequently, the knife edge 44 is pressed against the object 1 through the protective tape 41 from the rear face 31b side of the monocrystal sapphire substrate 31 along each of the lines 52, so as to exert an external force on the object 1 along each of the lines 52. This causes the fractures 82 occurring from the modified regions 72 to extend toward the rear face 31b, thereby cutting the object 1 into chips along each of the lines 52 (fourth step).

After cutting the object 1, the protective tape 41 is removed from the object 1, and the expandable tape 42 is expanded outward. As a consequence, a plurality of light-emitting elements 10, which were obtained by cutting the object 1 into the chips, are separated from each other.

The object cutting method of the second embodiment explained in the foregoing also exhibits effects similar to those of the above-mentioned object cutting method of the first embodiment concerning the plurality of lines to cut 51 set parallel to the a-plane and rear face 31b of the monocrystal sapphire substrate 31.

In addition, the step of cutting the object 1 presses the knife edge 44 against the object 1 from the rear face 31b side of the monocrystal sapphire substrate 31 along each of the lines 52, thereby exerting an external force on each of the lines 52. As a consequence, the external force acts on the object 1 such that the fractures 82 having reached the front face 31a of the monocrystal sapphire substrate 31 open, whereby the object 1 can be cut easily and accurately along the lines 52.

In each of the plurality of lines to cut 52 set parallel to the m-plane and rear face 31b of the monocrystal sapphire substrate 31, the object 1 is irradiated with the laser light L so as to satisfy t−[(d/2)−m]/tan α<Z<t−e, thereby forming the modified regions 72 within the monocrystal sapphire substrate 31 and causing the fractures 82 occurring from the modified regions 72 to reach the front face 31a. As a consequence, while keeping characteristics of the light-emitting element parts 32 from deteriorating upon irradiation with the laser light L, even when the extending direction of the fractures 82 occurring from the modified regions 72 is pulled toward the tilting direction of the r-plane, the fractures 82 can be contained in the street region 38 in the front face 31a of the monocrystal sapphire substrate 31, whereby the fractures 81 can be prevented from reaching the light-emitting element parts 32. Causing the fractures 82 occurring from the modified regions 72 to reach the front face 31a of the monocrystal sapphire substrate 31 can improve the cut quality of the element layer 33 in particular.

For example, when e (the minimum allowable distance from a position where the converging point P is located to the front face 31a): 50 μm, t (the thickness of the monocrystal sapphire substrate 31): 150 μm, d (the width of the street region 38): 30 μm, m (the amount of meandering of the fracture 82 in the front face 31a): 3 μm, and the tangent of α (the angle formed between the direction perpendicular to the rear face 31b and the extending direction of the rear face 82): 1/10, 30 μm<Z<100 μm from t−[(d/2)−m]/tan α<Z<t−e. It is therefore sufficient for the converging point P of the laser light L to be moved relatively along each of the lines 52 while being located at a position within the monocrystal sapphire substrate 31 separated from the rear face 31b by 30 to 100 μm.

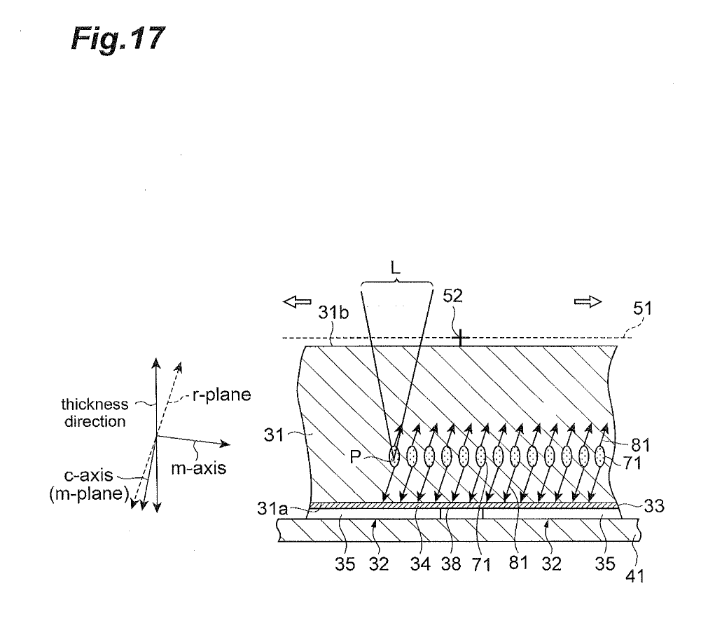

Meanwhile, forming the modified regions 71 along the lines 51 as follows makes it unnecessary to reverse the object 1 in the step of cutting the object 1. That is, as illustrated in FIG. 17, the converging point of the laser light L is relatively moved along each of the lines 51 while using the rear face 31b of the monocrystal sapphire substrate 31 as the entrance surface of the laser light L in the monocrystal sapphire substrate 31 and locating the converging point P within the monocrystal sapphire substrate 31. This forms the modified regions 71 within the monocrystal sapphire substrate 31 along each of the lines 51 and causes the fractures 81 occurring from the modified regions 71 to reach the front face 31a of the monocrystal sapphire substrate 31 in contrast to the case mentioned above (first step). At this time, the fractures 81 also extend from the modified regions 71 toward the rear face 31b of the monocrystal sapphire substrate 31 but do not reach the rear face 31b.

In this step, assuming that the side on which the r-plane and rear face 31b of the monocrystal sapphire substrate 31 form an acute angle is one side while the side on which they form an obtuse angle is the other side, the converging point P of the laser light L is relatively moved from the other side to the one side in all of the lines 51 in contrast to the above-mentioned case. For example, the distance from the position where the converging point P is located to the front face 31a is one half or less of the thickness of the monocrystal sapphire substrate 31, e.g., 50 to 70 μm. However, the distance from the position where the converging point P is located to the front face 31a is made not shorter than the minimum allowable distance e.

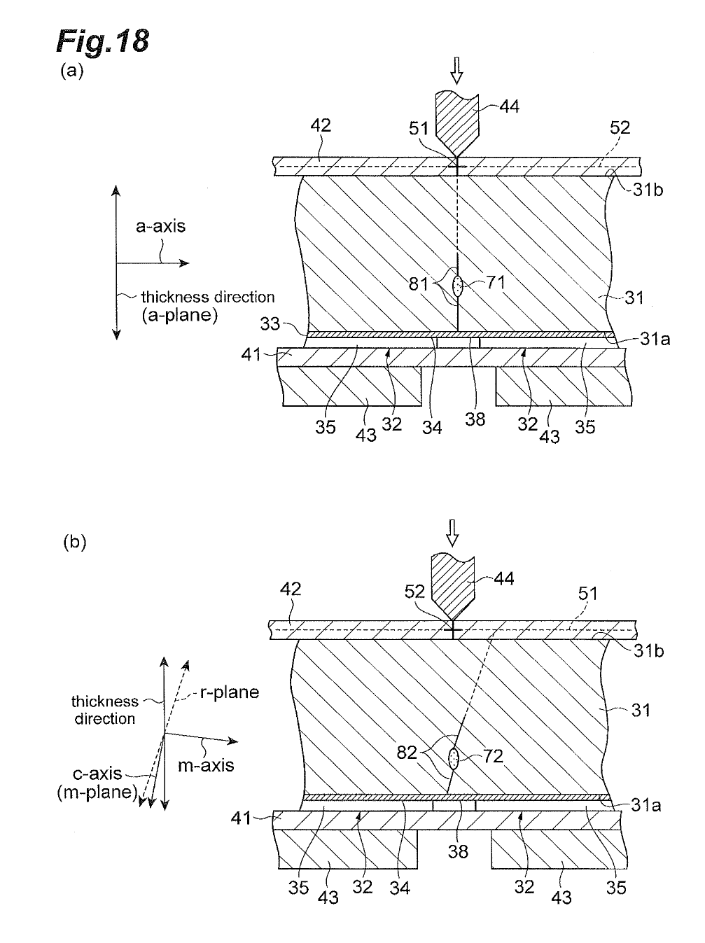

This causes not only the fractures 82 occurring from the modified regions 72 but also the fractures 81 occurring from the modified regions 71 to reach the front face 31a of the monocrystal sapphire substrate 31. Therefore, as illustrated in FIG. 18, the knife edge 44 can be pressed against the object 1 through the expandable tape 42 from the rear face 31b side of the monocrystal sapphire substrate 31 along each of the lines 51, 52, so as to cut the object 1 along each of the lines 51, 52. It thus becomes unnecessary to reverse the object 1 in the step of cutting the object 1.

By relatively moving the converging point P of the laser light from the other side to the one side in contrast to the above-mentioned case, the step of forming the modified regions 71 along the lines 51 can suppress the amount of meandering of the fractures 81 reaching the front face 31a of the monocrystal sapphire substrate 31 from the modified regions 71. Thus paying attention to which surface of the front and rear faces 31a, 31b of the monocrystal sapphire substrate 31 the fractures 81 occurring from the modified regions 71 should reach and relatively moving the converging point P of the laser light L from the side on which the r-plane and this surface of the monocrystal sapphire substrate 31 form an acute angle to the side on which they form an obtuse angle can suppress the amount of meandering of the fractures 81 reaching the surface.

### Third Embodiment

The object cutting method in accordance with the third embodiment of the present invention will now be explained in detail. The object cutting method of the third embodiment differs from the above-mentioned object cutting method of the first embodiment in the steps of forming the modified regions 71, 72. In the following, the object cutting method of the third embodiment will be explained mainly in terms of these different steps.

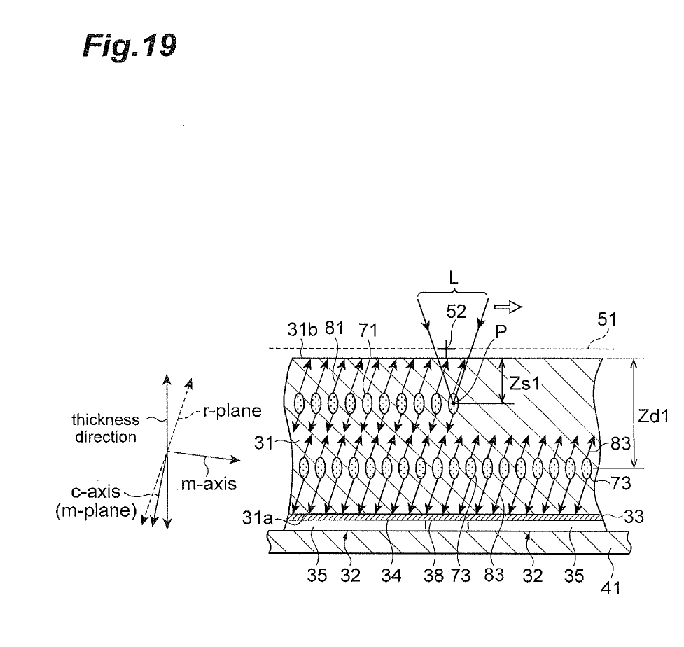

First, as illustrated in FIG. 19, the converging point P of the laser light L is relatively moved along one line to cut 51 while using the rear face 31b of the monocrystal sapphire substrate 31 as the entrance surface of the laser light L in the monocrystal sapphire substrate 31 and locating the converging point P at a position within the monocrystal sapphire substrate 31 separated by a distance (second distance) Zd1 from the rear face 31b. This forms a modified region (third modified region) 73 within the monocrystal sapphire substrate 31 along the one line 51. At this time, a fracture (third fracture) 83 occurring from the modified region 73 extends from the modified region 73 toward the front and rear faces 31a, 31b of the monocrystal sapphire substrate 31 but does not reach any of the front and rear faces 31a, 31b.

When forming the modified region 73, assuming that the side on which the r-plane and rear face 31b of the monocrystal sapphire substrate 31 form an acute angle is one side while the side on which they form an obtuse angle is the other side, the converging point P is relatively moved from the other side to the one side along the one line 51.

Subsequently, the converging point P of the laser light L is relatively moved along the one line to cut 51 while using the rear face 31b of the monocrystal sapphire substrate 31 as the entrance surface of the laser light L in the monocrystal sapphire substrate 31 and locating the converging point P at a position within the monocrystal sapphire substrate 31 separated by a distance (first distance) Zs1 shorter than the distance Zd1 from the rear face 31b. This forms the modified region 71 within the monocrystal sapphire substrate 31 along the one line 51 and causes the fracture 81 occurring from the modified region 71 to reach the rear face 31b. At this time, the fracture 81 occurring from the modified region 71 extends from the modified regions 71 toward the front face 31a of the monocrystal sapphire substrate 31 but does not reach the front face 31a.

When forming the modified region 71, assuming that the side on which the r-plane and rear face 31b of the monocrystal sapphire substrate 31 form an acute angle is one side while the side on which they form an obtuse angle is the other side, the converging point P is relatively moved from the other side to the one side along the one line 51.

The modified regions 71, 73 are sequentially formed as in the foregoing for each of all the lines 51 (first step). When forming the modified region 73, the distance from the position where the converging point P is located to the front face 31a is made not shorter than the minimum allowable distance e.

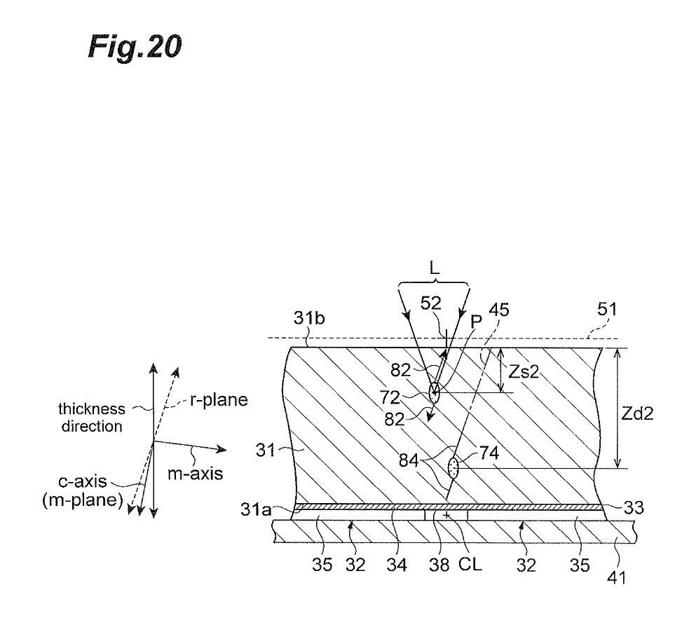

Next, as illustrated in FIG. 20, the converging point P of the laser light L is relatively moved along one line to cut 52 while using the rear face 31b of the monocrystal sapphire substrate 31 as the entrance surface of the laser light L in the monocrystal sapphire substrate 31 and locating the converging point P at a position within the monocrystal sapphire substrate 31 separated by a distance Zd2 from the rear face 31b. This forms a modified region (second modified region) 74 within the monocrystal sapphire substrate 31 along the one line 52. At this time, a fracture 84 occurring from the modified region 74 extends from the modified region 74 toward the front and rear faces 31a, 31b of the monocrystal sapphire substrate 31 but does not reach any of the front and rear faces 31a, 31b.

When forming the modified region 74, the object 1 is irradiated with the laser light L along each of the lines 52 so as to satisfy t−[(d/2)−m]/tan α<Z<t−e, where e is the minimum allowable distance from a position where the converging point P is located to the front face 31a, t is the thickness of the monocrystal sapphire substrate 31, Z is the distance from the rear face 31b to the position where the converging point P is located, d is the width of the street region 38 extending in a direction parallel to the m-plane between the light-emitting element parts 32, 32 adjacent to each other, in is the amount of meandering of the fracture 82 in the front face 31a, and α is the angle formed between the direction perpendicular to the rear face 31b (i.e., the thickness direction of the monocrystal sapphire substrate 31) and the fracture 82. This can keep characteristics of the light-emitting element parts 32 from deteriorating upon irradiation with the laser light L. Even when the extending direction of the fracture 84 occurring from the modified region 74 is pulled toward the tilting direction of the r-plane at the time of cutting the object 1 along the line 52, the fracture 84 can be contained in the street region 38 in the front face 31a of the monocrystal sapphire substrate 31, whereby the fracture 81 can be prevented from reaching the light-emitting element parts 32.

Subsequently, the converging point P of the laser light L is relatively moved along the one line to cut 52 while using the rear face 31b of the monocrystal sapphire substrate 31 as the entrance surface of the laser light L in the monocrystal sapphire substrate 31 and locating the converging point P at a position within the monocrystal sapphire substrate 31 separated by a distance Zs2 shorter than the distance Zd2 from the rear face 31b. This forms the modified region 72 within the monocrystal sapphire substrate 31 along the one line 52 and causes the fracture 82 occurring from the modified region 72 to reach the rear face 31b. At this time, the fracture 82 occurring from the modified region 72 extends from the modified region 72 toward the front face 31a of the monocrystal sapphire substrate 31 but does not reach the front face 31a.

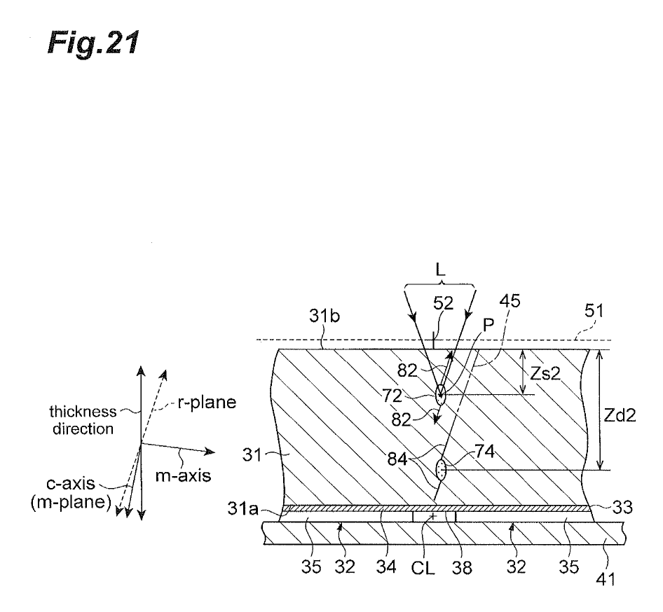

When forming the modified region 72, with respect to a tilted surface 45 passing the modified region 74 while being parallel to the r-plane of the monocrystal sapphire substrate 31, the modified region 72 is located on the side where the tilted surface 45 and the rear face 31b form an acute angle in each of the lines 52. More specifically, when seen in the direction perpendicular to the rear face 31b, the modified region 72 is positioned away from the tilted surface 45 than is the center line CL (coinciding with the line 52 here) of the street region 38 so that the fracture 82 having reached the rear face 31b is located on the center line CL. As illustrated in FIG. 21, however, the modified region 72 may be positioned closer to the tilted surface 45 than is the center line CL of the street region 38 so that the fracture 82 having reached the rear face 31b is located between the center line CL and the tilted surface 45 having reached the rear face 31b when seen in the direction perpendicular to the rear face 31b. It is only necessary for the modified region 72 to be formed along the line 52 such that the fracture 82 having reached the rear face 31b is located within the street region 38 or between the center line CL of the street region 38 and the tilted surface 45 having reached the rear face 31b.

The modified regions 72, 74 are sequentially formed as in the foregoing for each of all the lines 52 (third step). When forming the modified region 72, an example of the distance from the position where the converging point P is located to the rear face 31b is one half or less of the thickness of the monocrystal sapphire substrate 31, e.g., 30 to 50 μm.

After forming the modified regions 71 to 74 as in the foregoing, the expandable tape 42 is attached to the object 1 so as to cover the rear face 31b of the monocrystal sapphire substrate 31. Subsequently, the knife edge 44 is pressed against the object 1 through the protective tape 41 from the front face 31a side of the monocrystal sapphire substrate 31 along each of the lines 51 in the three-point bending breaking device, so as to exert an external force on the object 1 along each of the lines 51. This causes the fractures 81, 83 occurring from the modified regions 71, 73 to extend, thereby cutting the object 1 into bars along each of the lines 51 (second step). Then, the knife edge 44 is pressed against the object 1 through the protective tape 41 from the front face 31a side of the monocrystal sapphire substrate 31 along each of the lines 52, so as to exert an external force on the object 1 along each of the lines 52. This causes the fractures 82, 84 occurring from the modified regions 72, 74 to extend, thereby cutting the object 1 into chips along each of the lines 52 (fourth step).

After cutting the object 1, the protective tape 41 is removed from the object 1, and the expandable tape 42 is expanded outward. As a consequence, a plurality of light-emitting elements 10, which were obtained by cutting the object 1 into the chips, are separated from each other.

The object cutting method of the third embodiment explained in the foregoing also exhibits effects similar to those of the above-mentioned object cutting method of the first embodiment concerning the plurality of lines to cut 51 set parallel to the a-plane and rear face 31b of the monocrystal sapphire substrate 31.

In addition, the steps of forming the modified regions 71, 73 form the modified region 73 and then continuously the modified region 71 for each of the lines 51. The converging point P of the laser light L is moved in opposite directions when forming the modified regions 73, 71. This can efficiently move the converging point P of the laser light L. More specifically, the converging point P having relatively moved from the other side to one side when forming the modified region 73 in one line to cut 51 is relatively moved from the one side to the other side when forming the modified region 71, so as to return to the other side. Therefore, the irradiation with the laser light L can be started quickly in a line to cut 51 adjacent to the one line 51.

Forming a plurality of rows of modified regions 71, 73 for one line to cut 51 makes it possible to cut the object 1 easily and accurately along the line 51 even when the monocrystal sapphire substrate 31 is relatively thick. Forming a plurality of rows of modified regions 72, 74 for one line to cut 52 similarly makes it possible to cut the object 1 easily and accurately along the line 52 even when the monocrystal sapphire substrate 31 is relatively thick. This can also lower the pulse energy of the laser light L for forming one of the modified regions 71, 73 or one of the modified regions 72, 74, thereby making it possible to prevent characteristics of the light-emitting element parts 32 from deteriorating upon irradiation with the laser light L.

The step of cutting the object 1 presses the knife edge 44 against the object 1 from the front face 31a side of the monocrystal sapphire substrate 31 along each of the lines 51, 52, so as to exert an external force on the object 1 along each of the lines 51, 52. As a consequence, the external force acts on the object 1 such that the fractures 81, 82 having reached the rear face 31b of the monocrystal sapphire substrate 31 open, whereby the object 1 can be cut easily and accurately along the lines 51, 52.

In each of a plurality of lines to cut 52 set parallel to the m-plane and rear face 31b of the monocrystal sapphire substrate 31, with respect to the tilted surface 45 passing the modified region 74 while being parallel to the r-plane of the monocrystal sapphire substrate 31, the modified region 72 is positioned on the side where the tilted surface 45 and the rear face 31b form an acute angle. This enables the fracture 84 extending from the modified region 74 toward the rear face 31b to extend toward the modified region 72 and the fracture 82 extending from the modified region 72 toward the front face 31a to extend toward the modified region 74, whereby the fractures 84, 82 connect with each other within the monocrystal sapphire substrate 31. Hence, the fracture 84 occurring from the modified region 74 on the front face 31a side can be contained in the street region 38, while the fracture 82 occurring from the modified region 72 on the rear face 31b side is restrained from extending to the front face 31a of the monocrystal sapphire substrate 31, whereby the fractures 82, 84 can be prevented from reaching the light-emitting element parts 32.

While the object cutting methods in accordance with the first to third embodiments of the present invention are explained in the foregoing, the object cutting method of the present invention is not limited thereto.

For example, the step of forming the modified regions 71 may relatively move the converging point P of the laser light L from the side where the angle formed between the r-plane and rear face 31b of the monocrystal sapphire substrate 31 is an obtuse angle to the side where the angle is an acute angle in each of the lines 51. The fractures 82 occurring from the modified regions 71 when forming the modified regions 71 are not required to reach the rear face 31b. These can also inhibit the amount of meandering of the fractures 81 occurring from the modified regions 71 formed along each of the lines 51 from changing. At least this effect is exhibited regardless of how modified regions are formed along the lines 52.

As explained in the above-mentioned third embodiment, a plurality of rows of modified regions (which are not limited to two rows but may be three or more rows) may be formed for on line to cut when the monocrystal sapphire substrate 31 is relatively thick and so forth. In the line 51 in this case, relatively moving the converging point P of the laser light L from the side where the angle formed between the r-plane and rear face 31b of the monocrystal sapphire substrate 31 is an acute angle to the side where the angle is an obtuse angle at least at the time of forming the modified region 71 closest to the rear face 31b can suppress the amount of meandering of the fracture 81 reaching the rear face 31b of the monocrystal sapphire substrate 31 from the modified region 71 closest to the rear face 31b to the rear face 31b as compared with the case of relatively moving the converging point P of the laser light L in the opposite direction. In the lines 51, as in the forming of the modified regions 71, the converging point P of the laser light L may be relatively moved from the one side to the other side along each of the lines 51 at the time of forming other modified regions such as the modified regions 73. Thus moving the converging point P of the laser light L in the same direction when forming the modified regions 71, 73 enables the fractures 81 to securely reach the rear face 31b of the monocrystal sapphire substrate 31 when forming the modified regions 71.

When forming a plurality of rows of modified regions for one line to cut, the modified regions may be formed continuously for each line and sequentially for all the lines. Alternatively, modified regions located at an identical distance from the rear face 31b may be formed continuously, and then modified regions located at another identical distance from the rear face 31b may be formed continuously.

Either one of the step of forming the modified regions along the lines 51 and the step of forming the modified regions along the lines 52 may be performed earlier than the other as long as they occur before the step of cutting the object 1. Either one of the step of cutting the object 1 along the lines 51 and the step of cutting the object 1 along the lines 52 may be performed earlier than the other as long as they occur after the steps of forming the modified regions.

For relatively moving the converging point P of the laser light L along each of the lines 51, 52, the support table 107 of the laser processing device 100, parts on the laser light source 101 side of the laser processing device 100 (the laser light source 101, dichroic mirror 103, condenser lens 105, and the like), or both of them may be moved.

Semiconductor lasers may be manufactured as light-emitting elements. In this case, the object 1 comprises the monocrystal sapphire substrate 31, the n-type semiconductor layer (first conduction type semiconductor layer) 34 mounted on the front face 31a of the monocrystal sapphire substrate 31, an active layer mounted on the n-type semiconductor layer 34, and the p-type semiconductor layer (second conduction type semiconductor layer) 35 mounted on the active layer. The n-type semiconductor layer 34, active layer, and p-type semiconductor layer 35 are made of a III-V compound semiconductor such as GaN, for example, and construct a quantum well structure.

The element layer 33 may further comprise a contact layer for electrical connection with the electrode pads 36, 37. The first and second conduction types may be p- and n-types, respectively. The off-angle of the monocrystal sapphire substrate 31 may also be 0°. In this case, the front and rear faces 31a, 31b of the monocrystal sapphire substrate 31 become parallel to the c-plane.

### INDUSTRIAL APPLICABILITY

The present invention can provide an object cutting method which can inhibit the amount of meandering of fractures occurring from modified regions formed along each of a plurality of lines to cut which are parallel to the a-plane and rear face of a monocrystal sapphire substrate from fluctuating.

### REFERENCE SIGNS LIST

1: object to be processed; 10: light-emitting element; 31: monocrystal sapphire substrate; 31a: front face; 31b: rear face; 32: light-emitting element part; 33: element layer; 44: knife edge; 51: line to cut (first line to cut); 52: line to cut (second line to cut); 71: modified region (first modified region); 72, 74: modified region (second modified region); 73: modified region (third modified region); 81: fracture (first fracture); 82: fracture (second fracture); 83: fracture (third fracture); L: laser light; P: converging point.

1. An object cutting method for manufacturing a plurality of light-emitting elements by cutting an object to be processed, comprising a monocrystal sapphire substrate having front and rear faces forming an angle corresponding to an off-angle with c-plane and an element layer including a plurality of light-emitting element parts arranged in a matrix on the front face, with respect to each of the light-emitting element parts, the method comprising:
a first step of locating a converging point of laser light at a position separated by a first distance from the rear face within the monocrystal sapphire substrate, while using the rear face as an entrance surface of laser light in the monocrystal sapphire substrate, and relatively moving the converging point from one side to the other side along each of a plurality of first lines to cut set parallel to a-plane of the monocrystal sapphire substrate and the rear face, so as to form first modified regions within the monocrystal sapphire substrate along each of the first lines; and
a second step of exerting an external force on the object along each of the first lines after the first step, so as to extend a first fracture occurring from the first modified regions, thereby cutting the object along each of the first lines.

2. An object cutting method according to claim 1, wherein, in the first step, assuming that side where r-plane of the monocrystal sapphire substrate and the rear face form an acute angle is the one side while side where the r-plane and the rear face form an obtuse angle is the other side, the converging point is relatively moved from the one side to the other side along each of the first lines, so as to form the first modified regions within the monocrystal sapphire substrate and cause the first fracture to reach the rear face.

3. An object cutting method according to claim 2, wherein, in the second step, the external force is exerted on the object along each of the first lines by pressing a knife edge against the object from the rear face side along each of the first lines.

4. An object cutting method according to claim 1, further comprising:
a third step of locating the converging point within the monocrystal sapphire substrate, while using the rear face as the entrance surface, and relatively moving the converging point along each of a plurality of second lines to cut set parallel to m-plane of the monocrystal sapphire substrate and the rear face, so as to form second modified regions within the monocrystal sapphire substrate along each of the second lines before the second step; and
a fourth step of exerting an external force on the object along each of the second lines after the first and third steps, so as to extend a second fracture occurring from the second modified regions, thereby cutting the object along each of the second lines.

5. An object cutting method according to claim 1, wherein, in the first step, the converging point is located at a position separated by a second distance greater than the first distance from the rear face within the monocrystal sapphire substrate, while using the rear face as the entrance surface, and the converging point is relatively moved from the other side to the one side along each of the first lines, so as to form third modified regions within the monocrystal sapphire substrate along each of the first lines; and
wherein, in the second step, the external force is exerted on the object along each of the first lines, so as to extend the first fracture and a third fracture occurring from the third modified regions, thereby cutting the object along each of the first lines.

6. An object cutting method according to claim 1, wherein, in the first step, the converging point is located at a position separated by a second distance greater than the first distance from the rear face within the monocrystal sapphire substrate, while using the rear face as the entrance surface, and the converging point is relatively moved the converging point from the one side to the other side along each of the first lines, so as to form third modified regions within the monocrystal sapphire substrate along each of the first lines; and
wherein, in the second step, the external force is exerted on the object along each of the first lines, so as to extend the first fracture and a third fracture occurring from the third modified regions, thereby cutting the object along each of the first lines.
